(19) United States
(12) Patent Application Publication
(10) Pub. No.: US 2013/0194155 A1
(43) Pub. Date: Aug. 1, 2013

(54) WIRELESS COMMUNICATION SYSTEM, AND SMALL PORTABLE DEVICE, HOUSING CASE FOR A SMALL PORTABLE DEVICE, AND COMMUNICATION DEVICE FOR A SMALL PORTABLE DEVICE TO BE USED IN THE WIRELESS COMMUNICATION SYSTEM

(71) Applicants: Morihiro KURODA, Tokyo (JP); Shuichi KIKUCHI, Tokyo (JP)

(72) Inventors: Morihiro KURODA, Tokyo (JP); Shuichi KIKUCHI, Tokyo (JP)

(73) Assignee: SUMIDA CORPORATION, Tokyo (JP)

(21) Appl. No.: 13/755,675

(22) Filed: Jan. 31, 2013

(30) Foreign Application Priority Data
Feb. 1, 2012 (JP) 2012-020152
Aug. 22, 2012 (JP) 2012-182966

(51) Int. Cl. H01Q 7/00

(52) U.S. Cl. CPC H01Q 7/00
USPC 343/867

(57) ABSTRACT

A wireless communication system may include a first coil having at least a function of transmitting signal information, a relay coil, and a second coil having at least a function of receiving the signal information, and satisfying Equation (1): RO1>RO2>RO3, where RO1 represents an outer diameter of the first coil, RO2 represents an outer diameter of the relay coil, and RO3 represents an outer diameter of the second coil, and a small portable device, a housing case for a small portable device, and a communication device for a small portable device to be used in the wireless communication system.

### CROSS-REFERENCE TO RELATED APPLICATIONS

The present application claims priority from Japanese Patent Application No. 2012-020152 filed on Feb. 1, 2012 and Japanese Patent Application No. 2012-182966 filed on Aug. 22, 2012, the entirety of both applications is hereby incorporated by reference into this application.

### BACKGROUND

1. Field of the Invention

At least an embodiment of the present invention may relate to a wireless communication system, and a small portable device, a housing case for a small portable device, and a communication device for a small portable device to be used in the wireless communication system.

2. Description of the Related Art

In near field communication (NFC) for a communication range of about several to a dozen centimeters, data communication can be performed easily when one piece of equipment is brought close to or in contact with the other piece of equipment. In such wireless communication, a magnetic flux generated by a first coil having at least a function of transmitting signal information is converted to electric power by a second coil having at least a function of receiving the signal information to perform the communication. Such wireless communication system is utilized in various devices. Specific examples include a mobile telephone and an IC card having the second coil mounted therein. On the other hand, as a wireless power feed system, there is also known a configuration in which a relay coil is arranged between a transmission coil portion and a reception coil portion (see, for example, Japanese Patent Application Laid-open No. 2011-151989 (FIG. 1, paragraph 0031, etc.)). In the technology disclosed in Japanese Patent Application Laid-open No. 2011-151989, the electric power may be transmitted efficiently by using the relay coil.

The second coil may be mounted in devices of various sizes. In a device of relatively small size, in particular, a small portable device such as a mobile telephone or an IC card, the size and volume of the device itself are small, and hence the size of the second coil that can be mounted therein is also restricted severely. Therefore, it is basically preferred that the second coil be small in size, but when the second coil is reduced in size, a receiving sensitivity is reduced considerably. In terms of ensuring the receiving sensitivity, it is desired that the second coil be large in size to some extent. However, when the second coil is increased in size, reductions in thickness and size of the small portable device are hindered. In addition, a space that can otherwise be occupied by the other parts and members constituting the small portable device is taken up by the second coil.

### SUMMARY

At least an embodiment of the present invention has been made in view of the above-mentioned circumstances, and therefore has may provide a wireless communication system capable of suppressing a reduction in receiving sensitivity even when a second coil is reduced in size, and a small portable device, a housing case for a small portable device, and a communication device for a small portable device to be used in the wireless communication system.

That is, according to at least an embodiment of the present invention, there may be provided a wireless communication system, including: a first coil having at least a function of transmitting signal information; a relay coil; and a second coil having at least a function of receiving the signal information, the wireless communication system satisfying Equation (1) below:

RO1>RO2>RO3, Equation (1)

in Equation (1), RO1 represents an outer diameter of the first coil, RO2 represents an outer diameter of the relay coil, and RO3 represents an outer diameter of the second coil.

In an exemplary embodiment of the wireless communication system, the outer diameter of the second coil may be in a range of 10 mm to 20 mm.

In another exemplary embodiment of the wireless communication system, the wireless communication system may satisfy Equations (2) and (3) below:

RO2/RO3=2.0±0.5; and Equation (2)

RO1/RO2=2.0±0.5, Equation (3)

in Equations (2) and (3), RO1, RO2, and RO3 are defined in the same manner as in Equation (1).

In another exemplary embodiment of the wireless communication system with respect to a center axis direction of the relay coil, the first coil be arranged on one side of the relay coil and the second coil be arranged on another side of the relay coil.

In another exemplary embodiment of the wireless communication system when communication is performed, the first coil, the second coil, and the relay coil resonate.

In another exemplary embodiment of the wireless communication system at least the second coil be mounted in a small portable device.

In another exemplary embodiment of the wireless communication system the small portable device further have the relay coil mounted therein, and the relay coil be formed of a thin-film wiring.

In another exemplary embodiment of the wireless communication system the relay coil formed of the thin-film wiring be provided on an outer surface of the small portable device.

In another exemplary embodiment of the wireless communication system the small portable device include a housing, and the relay coil formed of the thin-film wiring be provided on at least one surface selected from an inner surface and an outer surface of the housing.

In another exemplary embodiment of the wireless communication system the housing include a housing main body, and a removable part which constitutes a portion of the inner surface and the outer surface of the housing and is removable from the housing main body, and the relay coil formed of the thin-film wiring be provided on at least one surface selected from a surface of the removable part that constitutes a portion of the inner surface of the housing and a surface of the removable part that constitutes a portion of the outer surface of the housing.

In another exemplary embodiment of the wireless communication system a housing case capable of housing the small portable device include the relay coil.

In another exemplary embodiment of the wireless communication system the small portable device be portable electronic equipment.

In another exemplary embodiment of the wireless communication system the small portable device be an IC card.

According to at least an embodiment of the present invention, there is provided a small portable device to be used in a wireless communication system, the wireless communication system including a first coil having at least a function of transmitting signal information, a relay coil, and a second coil having at least a function of receiving the signal information, and satisfying Equation (2) below:

RO1>RO2>RO3, Equation (2)

in Equation (2), RO1 represents an outer diameter of the first coil, RO2 represents an outer diameter of the relay coil, and RO3 represents an outer diameter of the second coil,

the small portable device having at least the second coil mounted therein.

According to at least an embodiment of the present invention, there is provided a housing case for a small portable device to be used in a wireless communication system, the wireless communication system including a first coil having at least a function of transmitting signal information, a relay coil, and a second coil having at least a function of receiving the signal information, and satisfying Equation (3) below:

RO1>RO2>RO3, Equation (3)

in Equation (3), RO1 represents an outer diameter of the first coil, RO2 represents an outer diameter of the relay coil, and RO3 represents an outer diameter of the second coil,

the second coil being mounted in the small portable device,

the housing case being capable of housing the portable electronic equipment and including the relay coil.

According to at least an embodiment of the present invention, there is provided a communication device for a small portable device to be used in a wireless communication system, the wireless communication system including a first coil having at least a function of transmitting signal information, a relay coil, and a second coil having at least a function of receiving the signal information, and satisfying Equation (4) below:

RO1>RO2>RO3, Equation (4)

in Equation (4), RO1 represents an outer diameter of the first coil, RO2 represents an outer diameter of the relay coil, and RO3 represents an outer diameter of the second coil,

the second coil being mounted in the small portable device,

the communication device having at least the function of transmitting the signal information to the small portable device and including the first coil.

According to at least an embodiment of the present invention, there may be provided a wireless communication system capable of suppressing the reduction in receiving sensitivity even when the second coil is reduced in size, and a small portable device, a housing case for a small portable device, and a communication device for a small portable device to be used in the wireless communication system.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which: In the accompanying drawings:

FIGS. 1A and 1B are schematic views illustrating an example of a wireless communication system according to an embodiment. Of the figures, FIG. 1A is a schematic cross-sectional view illustrating a state in which three kinds of coils constituting the wireless communication system are cut by a plane including center axes of the respective coils, and FIG. 1B is a schematic plan view of the three kinds of coils constituting the wireless communication system when viewed in a direction of the arrow ZD of FIG. 1A;

FIG. 2 is a schematic cross-sectional view illustrating another embodiment in which a relative arrangement relationship of the three kinds of coils constituting the wireless communication system illustrated in FIG. 1A is changed;

FIG. 3 is a schematic cross-sectional view illustrating yet another embodiment in which the relative arrangement relationship of the three kinds of coils constituting the wireless communication system illustrated in FIG. 1A is changed;

FIG. 4 is a schematic cross-sectional view illustrating still another embodiment in which the relative arrangement relationship of the three kinds of coils constituting the wireless communication system illustrated in FIG. 1A is changed;

FIG. 5 is a schematic cross-sectional view illustrating still another embodiment in which the relative arrangement relationship of the three kinds of coils constituting the wireless communication system illustrated in FIG. 1A is changed;

FIGS. 6A and 6B are schematic views illustrating a specific example of the wireless communication system according to the embodiment. Of the figures, FIG. 6A is a cross-sectional view of portable electronic equipment and a communication device, and FIG. 6B is a plan view illustrating a planar shape and an arrangement relationship of three kinds of coils illustrated in FIG. 6A;

FIGS. 7A and 7B are schematic views illustrating another specific example of the wireless communication system according to the embodiment. Of the figures, FIG. 7A is a cross-sectional view of an IC card and a communication device, and FIG. 7B is a schematic view illustrating an arrangement relationship of a second coil, an IC chip, and connection wirings in a planar direction of the IC card illustrated in FIG. 7A; and

FIGS. 8A and 8B are schematic views illustrating yet another specific example of the wireless communication system according to at least an embodiment of the embodiment. Of the figures, FIG. 8A is a cross-sectional view of an IC card, a communication device, and a housing case, and FIG. 8B is a schematic view illustrating planar shapes and an arrangement relationship of a relay coil and a protective film in a planar direction of the housing case illustrated in FIG. 8A.

### DETAILED DESCRIPTION

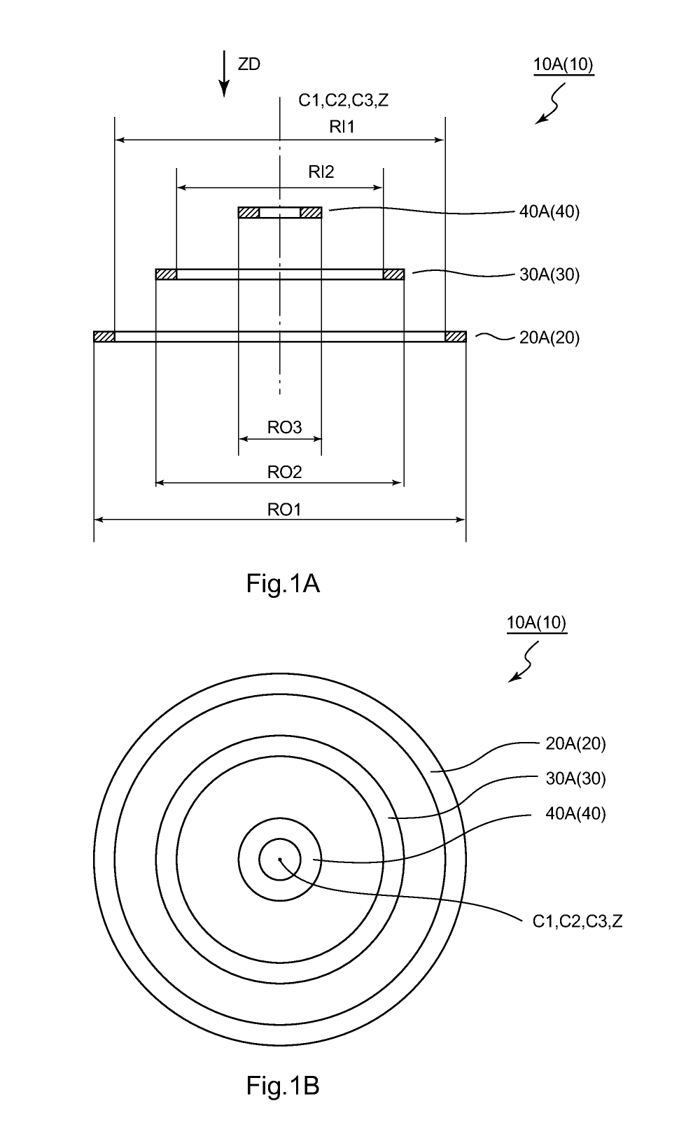

FIGS. 1A and 1B are schematic views illustrating an example of a wireless communication system according to an embodiment. Of the figures, FIG. 1A is a schematic cross-sectional view illustrating a state in which three kinds of coils 20A (20), 30A (30), and 40A (40) constituting a wireless communication system 10A (10) are cut by a plane including center axes C1, C2, and C3 of the respective coils 20, 30, and 40, and FIG. 1B is a schematic plan view illustrating the three kinds of coils 20A, 30A, and 40A constituting the wireless communication system 10A when viewed in a direction of the arrow ZD of FIG. 1A. In FIGS. 1A and 1B, illustration of components constituting the wireless communication system 10A other than the coils 20A, 30A, and 40A, and of lead wires and the like constituting the coils 20A, 30A, and 40A is omitted.

As illustrated in FIGS. 1A and 1B, the wireless communication system 10 according to the embodiment includes a first coil 20 having at least a function of transmitting signal information, a relay coil 30, and a second coil 40 having at least a function of receiving the signal information, and satisfies Equation (1) below:

RO1>RO2>RO3. Equation (1)

In Equation (1), RO1 represents an outer diameter of the first coil 20, RO2 represents an outer diameter of the relay coil 30, and RO3 represents an outer diameter of the second coil 40. Note that, in the specification of the subject application, the “outer diameter of the coil” means a maximum diameter of a contour shape (outer diameter shape) on an outer peripheral side of the coil. For example, the outer diameter of the coil means a diameter of a circle when the outer diameter shape of the coil is circular, the outer diameter of the coil means a longitudinal diameter of an ellipse when the outer diameter shape of the coil is elliptical, and the outer diameter of the coil means the length of a diagonal of a rectangle when the outer diameter shape of the coil is rectangular. Further, an “inner diameter of the coil” means a maximum diameter of a contour shape (inner diameter shape) on an inner peripheral side of the coil. For example, the inner diameter of the coil means a diameter of a circle when the inner diameter shape of the coil is circular, the inner diameter of the coil means a longitudinal diameter of an ellipse when the inner diameter shape of the coil is elliptical, and the inner diameter of the coil means the length of a diagonal of a rectangle when the inner diameter shape of the coil is rectangular.

Further, in the wireless communication system 10 according to at least an embodiment, a relative positional relationship among the first coil 20, the relay coil 30, and the second coil 40 is not particularly limited when no communication is performed. However, when communication is performed, generally, in a planar direction which is orthogonal to the center axis C1 of the first coil 20, the relay coil 30 is arranged so that a main part or an entirety of the relay coil 30 is located within a contour line on the outer peripheral side of the first coil 20, and the second coil 40 is arranged so that a main part or an entirety of the second coil 40 is located within the contour line on the outer peripheral side of the first coil 20 and within a contour line on the outer peripheral side of the relay coil 30. In this case, the first coil 20, the relay coil 30, and the second coil 40 be arranged so that the center axes C1, C2, and C3 of the respective coils 20, 30, and 40 are perfectly or substantially aligned. Note, however, that as long as a magnetic flux for the second coil 40 to generate a signal of a predetermined level or more is generated by the relay coil 30 and the second coil 40 by means of a magnetic flux generated by the first coil 20, the center axis C1 of the first coil 20 may not be aligned with the center axis C2 of the relay coil 30 and the center axis C3 of the second coil 40. However, also in this case, in terms of improving directivity and improving a receiving sensitivity in the second coil 40, the center axis C2 of the relay coil 30 may be aligned or substantially aligned with the center axis C3 of the second coil 40. In the example illustrated in FIGS. 1A and 1B, which illustrate a state at a time when communication is performed, the three kinds of coils 20A, 30A, and 40A are arranged so that the center axes C1, C2, and C3 of the respective coils 20A, 30A, and 40A are perfectly aligned. Note that, in the following description, an axis at which the three center axes C1, C2, and C3 are aligned may be referred to as a Z axis.

In the wireless communication system 10 according to at least an embodiment of the present invention, when communication is performed, a signal current flows through the first coil 20 to generate a magnetic flux passing through an inner peripheral side of the first coil 20. In a case where the relay coil 30 is not provided, in order to convert the magnetic flux formed by the first coil 20 back to a signal current in the second coil 40 at high efficiency, the size of the second coil 40 needs to be increased. However, in this method, the second coil 40A cannot be reduced in size.

However, in the wireless communication system 10 according to at least an embodiment, the relay coil 30 is used along with the first coil 20 and the second coil 40. Therefore, the relay coil 30 may orient the magnetic flux generated by the first coil 20 so as to efficiently direct the magnetic flux to the second coil 40 and increase the density of a magnetic flux passing through an inner peripheral side of the second coil 40. Therefore, with the wireless communication system 10 according to at least an embodiment of the present invention, it is possible to suppress a reduction in the receiving sensitivity even when the second coil 40 is reduced in size. Note that, in this case, when communication is performed, the first coil 20, the second coil 40, and the relay coil 30 resonate at the same frequency.

Further, in the wireless communication system 10 according to at least an embodiment, arrangement positions of the three kinds of coils 20A, 30A, and 40A with respect to the direction of the center axis C2 of the relay coil 30 are not particularly limited. However, it may be that, as illustrated in FIGS. 1A and 1B, with respect to the direction of the center axis C2 of the relay coil 30, the first coil 20 be arranged on one side of the relay coil 30 and the second coil 40 be arranged on the other side of the relay coil 30. When the three kinds of coils 20A, 30A, and 40A are arranged as described above, it is possible to maximize the function of the relay coil 30 of orienting the magnetic flux generated by the first coil 20 so as to efficiently direct the magnetic flux to the second coil 40 and increase the density of the magnetic flux passing through the inner peripheral side of the second coil 40.

Therefore, it is also possible, in the device which is to be used in the wireless communication system 10 according to at least an embodiment and has at least the second coil 40 mounted therein, to reduce the space occupied by the second coil 40 and suppress the reduction in receiving sensitivity. As a result, (1) the reduction in size of the device having the second coil 40 mounted therein, and/or (2) conversion of the free space produced by the reduction in space occupied by the second coil in the device to another application are/is facilitated.

Note that, the first coil 20 is connected as appropriate to, for example, a power source or a circuit board, the relay coil 30 is connected to a capacitor, and the second coil 40 is connected as appropriate to, for example, a power source, a circuit board, or an IC chip. Further, in the wireless communication system 10 according to at least an embodiment of the present invention, it is sufficient when the first coil 20 has at least the function of transmitting the signal information (transmission function) and the second coil 40 has at least the function of receiving the signal information (reception function). However, in the wireless communication system 10 according to at least an embodiment, the first coil 20 may have the reception function in addition to the transmission function and the second coil 40 may have the transmission function in addition to the reception function as needed.

The device which is to be used in the wireless communication system 10 according to the at least an embodiment and has at least the second coil 40 mounted therein is not particularly limited, but in terms of facilitating effective use of the above-mentioned advantages (1) and (2), the device may be a small portable device. In the specification of the subject application, the “small portable device” means a device that can be easily carried around by a person. This small portable device may have, but is not limited to, a size of substantially 1,500 cm³ or less in volume and have a weight of substantially 3.0 kg or less. Examples of the small portable device include portable electronic equipment and an IC card. Examples of the portable electronic equipment include (but are not limited to) a notebook computer, a portable music player, a mobile telephone, a smartphone, a personal digital assistant (PDA), and an IC recorder. Note that, among those small portable devices, the notebook computer, the mobile telephone, the smartphone, the PDA, and the IC card, which are considerably limited in space in the thickness direction.

Note that, in the portable electronic equipment in which the inner space is extremely limited, generally, the second coil 40 needs to be connected via a connector to a circuit board arranged in the portable electronic equipment. Therefore, with respect to the inner space, the occupied space resulting from the second coil 40 and members such as a connector associated to the second coil 40 is extremely large. However, with the wireless communication system 10 according to at least an embodiment, the second coil 40 may be reduced in size. Therefore, the occupied space resulting from the second coil 40 and the like with respect to the inner space may be reduced. Further, it is extremely easy to surface-mount the second coil 40, which is reduced in size, to the circuit board without using the connector. In this case, it is possible to eliminate the occupied space resulting from the connector.

Further, in the IC card, when the second coil 40 mounted in the IC card can be reduced in size, the distance of the wiring or lead wire constituting the second coil 40 may be reduced. In addition, arranging the second coil 40 at a position close to the IC chip mounted in the IC card also becomes easier. Also in this case, the distance of the wiring for connecting the IC chip and the second coil 40 may be further reduced. On the other hand, the IC card, which is often carried around in a wallet or a pass case carried by a person on a daily basis, is often subjected to an extreme bending stress or frequent bending stresses due to an action of standing up, sitting down, lying on the floor, or walking of the person. Therefore, when the second coil 40 is large and/or when the IC chip and the second coil 40 are arranged at spaced apart positions, it is highly likely that a long wiring or lead wire will be disconnected, which may easily result in the loss of the communication function of the IC card. However, with the wireless communication system 10 according to at least an embodiment, the occurrence of the problem as described above may be easily prevented.

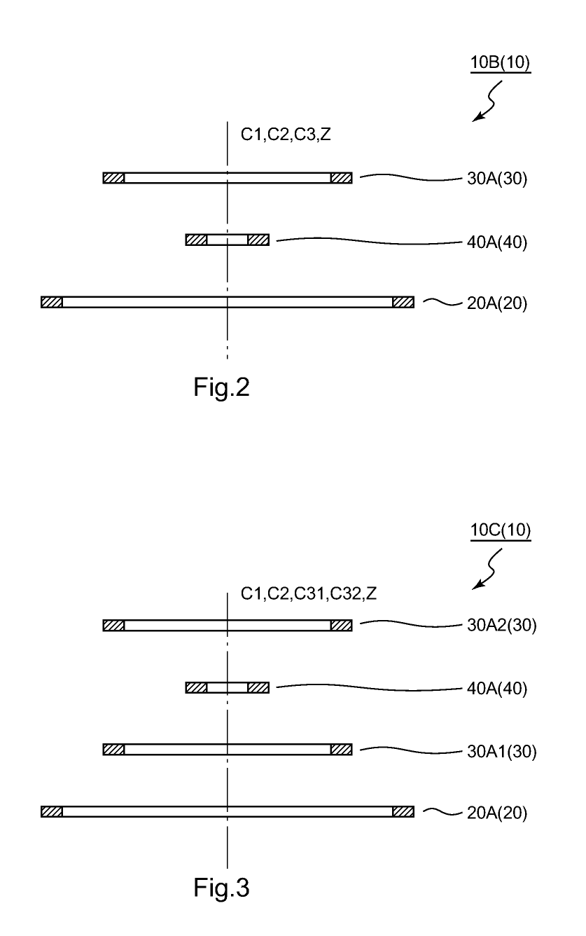

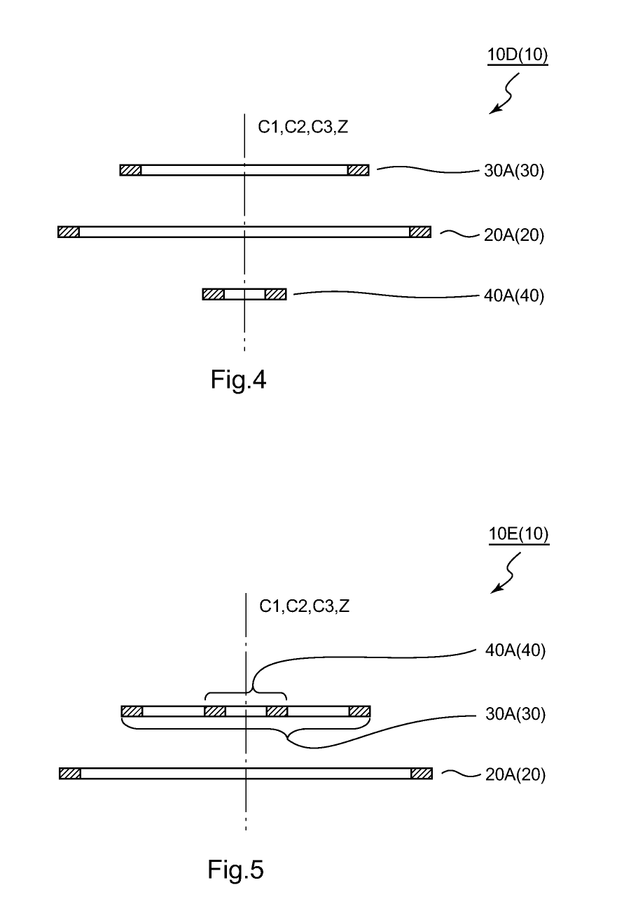

Next, with regard to the wireless communication system 10 according to at least an the embodiment, embodiments other than the embodiment illustrated in FIGS. 1A and 1B and more specific configurations are described. In the example illustrated in FIGS. 1A and 1B, from one side to the other side of the center axis C1 of the first coil 20, the first coil 20, the relay coil 30, and the second coil 40 are arranged in this order. However, the arrangement relationship of the three kinds of coils 20, 30, and 40 with respect to the center axis C1 is not particularly limited and may be selected as appropriate. For example, the arrangement from the one side to the other side of the center axis C1 may be: (1) in the order of the first coil 20, the second coil 40, and the relay coil 30 (FIG. 2); (2) in the order of the first coil 20, the relay coil 30, the second coil 40, and the relay coil 30 (FIG. 3); or (3) in the order of the second coil 40, the first coil 20, and the relay coil 30 (FIG. 4). Further, with respect to the center axis C1, at least any two of the three kinds of coils 20, 30, and 40 may be arranged at the same position, and for example, as illustrated in FIG. 5, the relay coil 30 and the second coil 40 may be arranged at the same position with respect to the center axis C1. Note that, FIGS. 2 to 5 illustrate, in schematic cross-sectional views, wireless communication systems 10B (10), 10C (10), 10D (10), and 10E (10), which are embodiments in which a relative arrangement relationship of the three kinds of coils 20A, 30A, and 40A constituting the wireless communication system 10A illustrated in FIG. 1A is changed. In FIG. 3, one of the two relay coils 30 represents a first relay coil 30A1 and the other represents a second relay coil 30A2, and symbols C31 and C32 denote center axes of the first relay coil 30A1 and the second relay coil 30A2, respectively.

Further, in terms of attaining both the reduction in size of the second coil 40 and the securement of the receiving sensitivity in a balanced manner, the outer diameter of the second coil 40 be in a range of 10 mm to 20 mm. Note that, for reference, the outer diameter of the second coil mounted in conventional portable electronic equipment such as a mobile telephone is about 30 mm to 40 mm, and the outer diameter of the second coil mounted in a conventional IC card is about 60 mm to 80 mm.

Further, the outer diameter RO1 of the first coil 20, the outer diameter RO2 of the relay coil 30, and the outer diameter RO3 of the second coil 40 may satisfy not only Equation (1) but also Equations (2) and (3) below:

RO2/RO3=2.0±0.5; and Equation (2)

RO1/RO2=2.0±0.5. Equation (3)

In other words, RO1, RO2, and RO3 may be set to a ratio of about 4:2:1, (but are not limited to this ratio). When the relative ratio of RO1, RO2, and RO3 is set in a range expressed by Equations (2) and (3), the attainment of both the reduction in size of the second coil 40 and the securement of the receiving sensitivity in a balanced manner may be facilitated. In addition, in the IC card or the portable electronic equipment, which may be used with an automatic ticket checker at a station, when communication is performed, the relay coil 30 and the second coil 40 move relative to the first coil 20, or the second coil 40 moves relative to the first coil 20 and the relay coil 30. In such case, it is necessary that the signal information may be received even when the relative positions of those three kinds of coils 20, 30, and 40 are changed. However, when the relative ratio of RO1, RO2, and RO3 is set in the range expressed by Equations (2) and (3), a sufficient receivable range may be easily secured for the amount of relative positional change among the three kinds of coils 20, 30, and 40.

Further, inner diameters of the respective coils 20, 30, and 40 are not particularly limited. However, as illustrated in FIGS. 1A and 1B, the inner diameter RI2 of the relay coil 30 be larger than the outer diameter RO3 of the second coil 40 and the inner diameter RI1 of the first coil 20 be larger than the outer diameter RO2 of the relay coil 30.

Each of the first coil 20, the relay coil 30, and the second coil 40 may be constituted of, for example, a wound lead wire or a thin-film wiring arranged in a spiral pattern on a planar surface of an insulating film or an insulating substrate. Note that, as the method of forming the thin-film wiring, a known method may be used as appropriate. Examples of the known method include a method of forming the thin-film wiring by screen printing using a conductive paste containing silver and the like, and a method of forming the thin-film wiring by patterning a conductive thin film, which is formed on a planar surface, by photolithography or etching. Further, when the device having at least the second coil 40 mounted therein is the small portable device and the second coil 40 is constituted of the thin-film wiring, a further reduction in size of the small portable device or the conversion of the free space produced by the reduction in the space occupied by the second coil 40 in the small portable device to another application may be facilitated.

Further, the relay coil 30 is mounted to at least any one selected from: (a) a device having at least the first coil 20 mounted therein; (b) the device having at least the second coil 40 mounted therein; and (c) a device or member other than the devices (a) and (b).

Note that, when the device having at least the second coil 40 mounted therein is a small portable device, the small portable device may have the relay coil 30 mounted therein. In this case, the relay coil 30 may be formed of a thin-film wiring. In this manner, even if the small portable device has the relay coil 30 mounted therein in addition to the second coil 40, it is possible to prevent an increase in size of the small portable device due to the relay coil 30.

Further, the relay coil 30 basically does not need to be connected to a power source or a circuit board as opposed to the first coil 20 and the second coil 40, which are used directly for transmitting and receiving the signal information. Therefore, the flexibility of the arrangement position of the relay coil 30 in the small portable device is high as compared to the second coil 40. When this point is also taken into consideration, constituting the relay coil 30 of the thin-film wiring may facilitate the effective use of the free space inside and/or on an outer surface of the small portable device to arrange the relay coil 30.

In this case, the relay coil 30 formed of the thin-film wiring may be provided on the outer surface of the small portable device. Further, when the small portable device has a housing, the relay coil 30 formed of the thin-film wiring may be provided on at least one surface selected from an inner surface or an outer surface of the housing.

Further, when the housing includes a housing main body and a removable part which constitutes a portion of the inner surface and the outer surface of the housing and is removable from the housing main body, the relay coil 30 formed of the thin-film wiring may be provided on at least one surface selected from a surface of the removable part that constitutes a portion of the inner surface of the housing and a surface of the removable part that constitutes a portion of the outer surface of the housing. Note that, examples of the removable part include, in a case where a replaceable battery, recording medium, IC chip, or other such member is placed in the housing, a housing lid to be attached to the housing main body when such member is inserted in or removed from the housing.

Further, when the small portable device having the second coil 40 mounted therein does not have the relay coil 30 mounted therein, the relay coil 30 may be provided to the device having the first coil 20 mounted therein. Alternatively, however, the relay coil 30 may be provided to a housing case capable of housing the small portable device. Examples of the housing case include a protective case, a holder, and a housing cover used for an IC card, a mobile telephone, a smartphone, or a PDA.

Note that, examples of the device (communication device) having at least the first coil 20 mounted therein include, but are not particularly limited to, an automatic ticket checker placed at a ticket gate of a station, a security gate or a reader/writer for the purpose of identification or attendance monitoring placed at an entrance of a building or an office, a reader/writer used for payment of a bill or the like at a store, and a reader/writer used for checking and matching various kinds of personal information such as the bank balance and the family register in a bank or a city office.

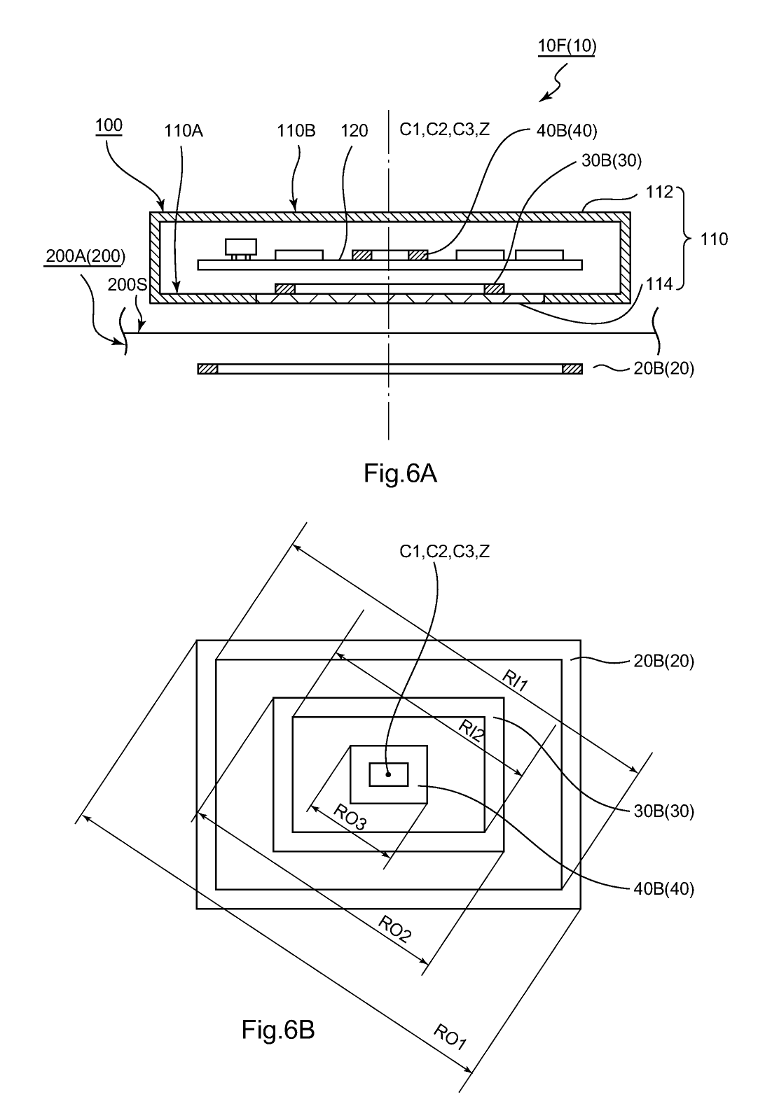

FIGS. 6A and 6B are schematic views illustrating a specific example of the wireless communication system 10 according to the an embodiment, specifically, schematic views illustrating the small portable device (portable electronic equipment) having the relay coil 30 and the second coil 40 mounted therein, and the communication device for a small portable device having the first coil 20 mounted therein. Of the figures, FIG. 6A is a cross-sectional view of portable electronic equipment 100 and a communication device 200A (200), and FIG. 6B is a plan view illustrating a planar shape and an arrangement relationship of three kinds of coils 20B (20), 30B (30), and 40B (40) illustrated in FIG. 6A. Note that, FIG. 6A illustrates only a main part of the portable electronic equipment 100 and the communication device 200A, and illustration of the other constituent elements is omitted. Illustration of lead wires or wirings constituting the three kinds of coils 20B, 30B, and 40B is also omitted.

A wireless communication system 10F (10) illustrated in FIGS. 6A and 6B includes small portable equipment (portable electronic equipment 100) having the relay coil 30B and the second coil 40B mounted therein, and the communication device 200A having the first coil 20B mounted therein. In this example, the portable electronic equipment 100 includes a housing 110, a circuit board 120 placed in the housing 110, the second coil 40B mounted on a surface of the circuit board 120, and the relay coil 30B provided on an inner surface 110A of the housing 110. The housing 110 has a cross section of a rectangular contour shape. The circuit board 120 is placed in the housing 110 so that a planar surface of the circuit board 120 is parallel to a planar surface of an outer surface 110B of the housing 110 that extends in a longitudinal direction.

The housing 110 further includes a housing main body 112 and a removable part (lid 114) that is removable from the housing main body 112. The relay coil 30B is provided to the inner surface 110A portion of the lid 114. In addition, the surface of the circuit board 120 on which the second coil 40B is mounted and the inner surface 110A portion of the lid 114 are parallel to each other. Further, in a state in which the lid 114 is attached to the housing main body 112, the center axis C2 of the relay coil 30B and the center axis C3 of the second coil 40B are aligned. Also, the first coil 20B is arranged in the communication device 200A so that the center axis C1 of the first coil 20B is orthogonal to a surface (communication surface 200S) of the communication device 200A.

Note that, as illustrated in FIG. 6B, planar shapes of the three kinds of coils 20B, 30B, and 40B are each a rectangular ring and satisfy Equation (1).

When communication is performed, as illustrated in FIGS. 6A and 6B, for example, a good receiving sensitivity may be secured when the portable electronic equipment 100 is brought in proximity to or in contact with the communication surface 200S of the communication device 200A so that the center axis C2 of the relay coil 30B and the center axis C3 of the second coil 40B are aligned with the center axis C1 of the first coil 20B. Within a range in which a good receiving sensitivity may be secured, a relative arrangement relationship among the first coil 20B, the relay coil 30B, and the second coil 40B when the communication is performed may deviate to some extent from the embodiment illustrated in FIGS. 6A and 6B.

Note that, in addition to the relay coil 30B illustrated in FIGS. 6A and 6B, at least one relay coil 30B may be provided at an arbitrary position on the inner surface 110A and/or the outer surface 110B of the housing 110 so that the center axis C2 of the relay coil 30B is aligned or substantially aligned with the center axis C3 of the second coil 40B. Further, a relay coil 30B may be provided also on the communication device 200A side. In this case, the relay coil 30B may be arranged as appropriate in the vicinity of the first coil 20B or on a surface of the communication surface 200S so that the center axis C2 of the relay coil 30B is aligned or substantially aligned with the center axis C1 of the first coil 20B.

Further, when the relay coil 30B is arranged on the outer surface 110B of the housing 110 or on the communication surface 200S, a sheet may be used with a relay coil, in which at least the relay coil 30B constituted of a thin-film wiring is arranged on one surface of a resin film and the other side of the resin film is an adhesive surface. In this case, by merely attaching the sheet with a relay coil to equipment (the small portable device such as the portable electronic equipment or the IC card, and the communication device) constituting an existing wireless communication system without the relay coil 30, the existing wireless communication system may be changed to the wireless communication system 10 according to at least an embodiment in an extremely simple manner.

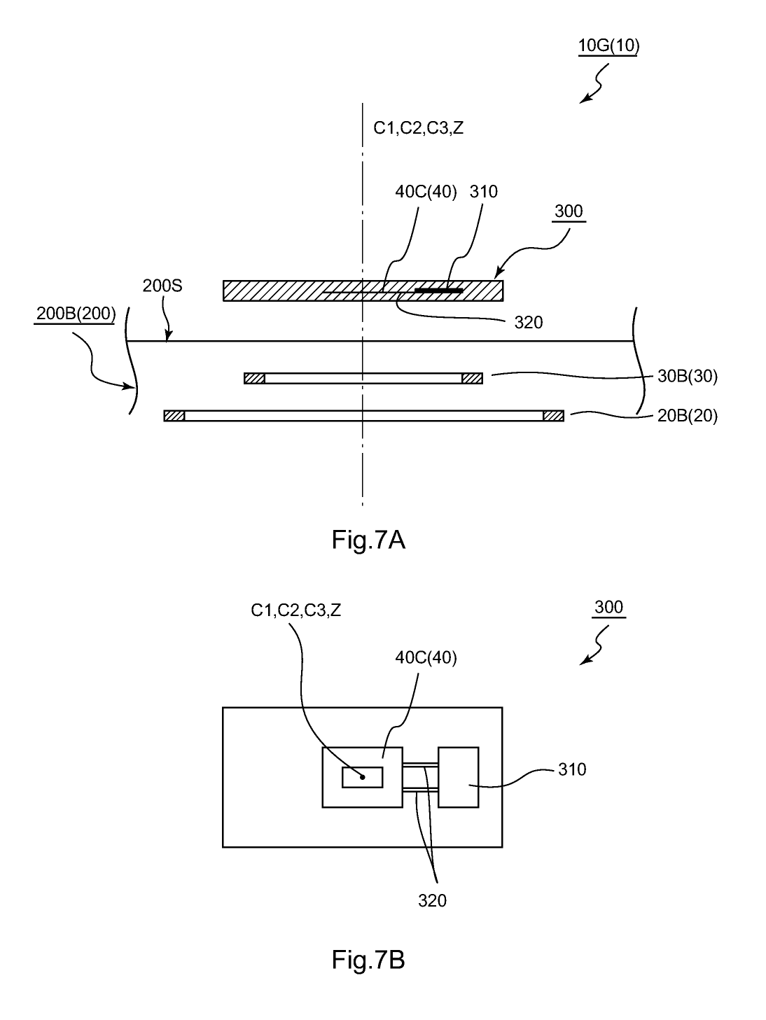

FIGS. 7A and 7B are schematic views illustrating another specific example of the wireless communication system 10 according to an embodiment, specifically, schematic views illustrating the small portable device (IC card) having the second coil 40 mounted therein, and the communication device for a small portable device having the first coil 20 and the relay coil 30 mounted therein. Of the figures, FIG. 7A is a cross-sectional view of an IC card 300 and a communication device 200B (200), and FIG. 7B is a schematic view illustrating an arrangement relationship of a second coil 40C (40), an IC chip 310, and connection wirings 320 in a planar direction of the IC card 300 illustrated in FIG. 7A. Note that, FIG. 7A illustrates only a main part of the IC card 300 and the communication device 200B, and illustration of the other constituent elements is omitted. Illustration of lead wires or wirings constituting the three kinds of coils 20B, 30B, and 40C is also omitted.

A wireless communication system 10G (10) illustrated in FIGS. 7A and 7B includes small portable equipment (IC card 300) having the second coil 40C (40) mounted therein, and the communication device 200B having the first coil 20B and the relay coil 30B mounted therein. In this example, the plate-like IC card 300 having a rectangular planar shape includes the second coil 40C constituted of a wiring formed as a thin film at a substantially center portion in a thickness direction of the IC card 300, the IC chip 310 connected to the second coil 40C, and the connection wirings 320 for connecting the second coil 40C and the IC chip 310. Note that, the IC card 300 is constituted of a plurality of sheet-like members (not shown) laminated on top of one another, and the second coil 40C, the IC chip 310, and the connection wirings 320 are arranged on a surface of any one of the sheet-like members. Further, in the planar direction of the IC card 300, the second coil 40C is arranged at a position that is in the vicinity of the center portion of the IC card 300 and spaced apart from all four sides as outer peripheral edges of the IC card 300. The IC chip 310 is arranged in the vicinity of the second coil 40C, and the second coil 40C and the IC chip 310 are connected by the connection wirings 320. Note that, the size and shape in the planar direction of the second coil 40C are substantially the same as those of the second coil 40B illustrated in FIGS. 6A and 6B.

Further, in the communication device 200B, the relay coil 30B and the first coil 20B are arranged in this order from the communication surface 200S side so that the center axis C2 of the relay coil 30B and the center axis C1 of the first coil 20B are aligned.

When communication is performed, as illustrated in FIGS. 7A and 7B, for example, a good receiving sensitivity may be secured when the IC card 300 is brought in proximity to or in contact with the communication surface 200S of the communication device 200B so that the center axis C3 of the second coil 40B is aligned with the center axis C1 of the first coil 20B and the center axis C2 of the relay coil 30B. Within a range in which a good receiving sensitivity may be secured, a relative arrangement relationship among the first coil 20B, the relay coil 30B, and the second coil 40B when the communication is performed may deviate to some extent from the embodiment illustrated in FIGS. 7A and 7B. Further, when the communication is performed, electric power may be supplied to the IC chip 310 simultaneously.

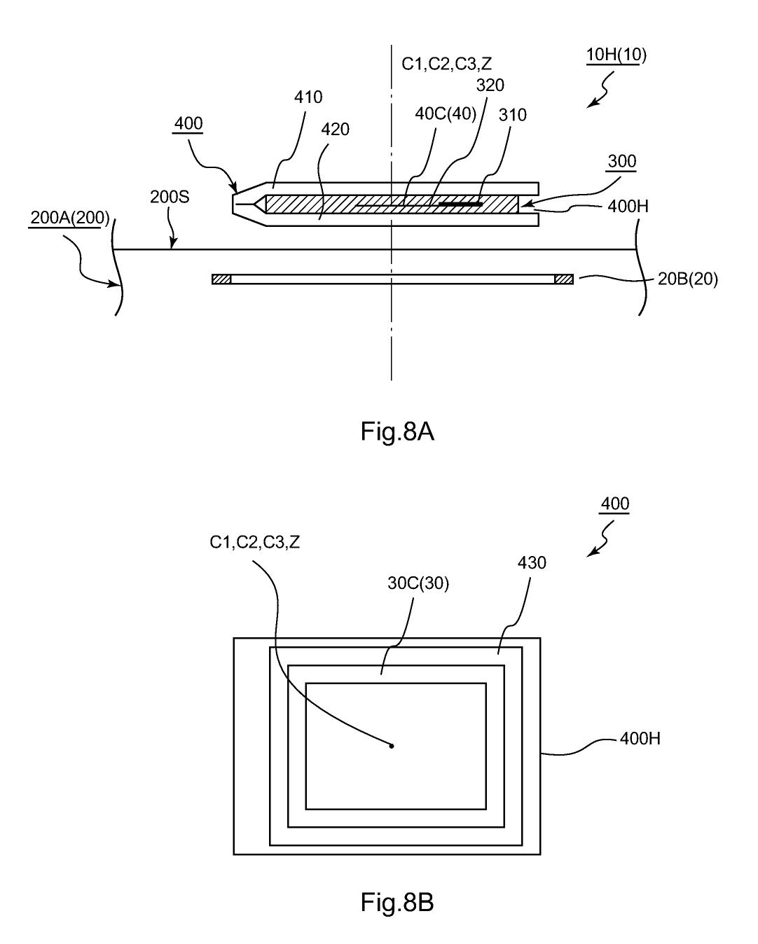

FIGS. 8A and 8B are schematic views illustrating yet another specific example of the wireless communication system 10 according to at least an embodiment, specifically, schematic views illustrating the IC card 300 illustrated in FIGS. 7A and 7B, the communication device 200A illustrated in FIGS. 6A and 6B, and a housing case 400 housing the IC card 300 and having a relay coil 30C (30) mounted therein. Of the figures, FIG. 8A is a cross-sectional view of the IC card 300, the communication device 200A, and the housing case 400, and FIG. 8B is a schematic view illustrating arrangement positions and planar shapes of the relay coil 30C and a protective film 430 in a planar direction of the housing case 400 illustrated in FIG. 8A. Note that, FIG. 8A illustrates only a main part of the IC card 300, the communication device 200A, and the housing case 400, and illustration of the other constituent elements is omitted. Illustration of lead wires or wirings constituting the three kinds of coils 20B, 30C, and 40C is also omitted.

A wireless communication system 10H (10) illustrated in FIGS. 8A and 8B includes small portable equipment (IC card 300) having the second coil 40C (40) mounted therein, the communication device 200A having the first coil 20B mounted therein, and the housing case 400 having the relay coil 30C mounted therein.

In this example, the housing case 400 has a structure in which a first sheet 410 having a rectangular planar shape and a second sheet 420 having the same planar shape as that of the first sheet 410 are bonded at edge portions of the respective sheets 410 and 420. Note, however, that one of a pair of short sides of the sheet 410 and one of a pair of short sides of the sheet 420 are not bonded. In other words, one of a pair of short sides of the housing case 400 forms an opening portion 400H. Further, inside the housing case 400, that is, on a surface of the second sheet 420 that faces the first sheet 410, the relay coil 30C (not shown in FIG. 8A) formed of a thin-film wiring and the protective film 430 (not shown in FIG. 8A) for covering the relay coil 30C are provided. Note that, in the planar direction of the second sheet 420, the relay coil 30C is arranged at a position that allows the center axis C2 of the relay coil 30C and the center axis C3 of the second coil 40C to be aligned or substantially aligned when the IC card 300 is housed in the housing case 400. Note that, the protective film 430 has a planar shape that is slightly larger than an outer shape of the relay coil 30C. Further, the size and shape in the planar direction of the relay coil 30C are substantially the same as those of the relay coil 30 illustrated in FIGS. 6A and 6B.

When communication is performed, as illustrated in FIGS. 8A and 8B, for example, a good receiving sensitivity may be secured when the housing case 400 and the IC card 300 housed in the housing case 400 are brought in proximity to or in contact with the communication surface 200S of the communication device 200A so that the center axis C2 of the relay coil 30C and the center axis C3 of the second coil 40C are aligned with the center axis C1 of the first coil 20B. Within a range in which a good receiving sensitivity may be secured, a relative arrangement relationship among the first coil 20B, the relay coil 30C, and the second coil 40C when the communication is performed may deviate to some extent from the embodiment illustrated in FIGS. 8A and 8B. Further, when the communication is performed, electric power may be supplied to the IC chip 310 simultaneously.

The specific examples of the wireless communication system 10 according to at least an embodiment have been described above with reference to FIGS. 6A to 8B, but embodiments other than FIGS. 6A to 8B may be employed as appropriate. Three kinds of coils 20, 30, and 40 may be provided. For example, the wireless communication system 10 according to at least an embodiment may be configured by combining, with the communication device 200B illustrated in FIGS. 7A and 7B, the portable electronic equipment 100 illustrated in FIGS. 6A and 6B, or the housing case 400 and the IC card 300 housed in the housing case 400 illustrated in FIGS. 8A and 8B.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A wireless communication system, comprising:
a first coil having at least a function of transmitting signal information;
a relay coil; and
a second coil having at least a function of receiving the signal information,
the wireless communication system satisfying Equation (1) below:
RO1>RO2>RO3, Equation (1)
in Equation (1), RO1 represents an outer diameter of the first coil, RO2 represents an outer diameter of the relay coil, and RO3 represents an outer diameter of the second coil.

2. A wireless communication system according to claim 1, wherein the outer diameter of the second coil is in a range of 10 mm to 20 mm.

3. A wireless communication system according to claim 1, wherein the wireless communication system satisfies Equations (2) and (3) below:
RO2/RO3=2.0±0.5; and Equation (2)
RO1/RO2=2.0±0.5, Equation (3)
in Equations (2) and (3), RO1, RO2, and RO3 are defined in the same manner as in Equation (1).

4. A wireless communication system according to claim 1, wherein, with respect to a center axis direction of the relay coil, the first coil is arranged on one side of the relay coil and the second coil is arranged on another side of the relay coil.

5. A wireless communication system according to claim 1, wherein, when communication is performed, the first coil, the second coil, and the relay coil resonate.

6. A wireless communication system according to claim 1, wherein at least the second coil is mounted in a small portable device.

7. A wireless communication system according to claim 6,
wherein the small portable device further has the relay coil mounted therein, and
wherein the relay coil is formed of a thin-film wiring.

8. A wireless communication system according to claim 7, wherein the relay coil formed of the thin-film wiring is provided on an outer surface of the small portable device.

9. A wireless communication system according to claim 7,
wherein the small portable device includes a housing, and
wherein the relay coil formed of the thin-film wiring is provided on at least one surface selected from an inner surface and an outer surface of the housing.

10. A wireless communication system according to claim 9,
wherein the housing comprises a housing main body, and a removable part which constitutes a portion of the inner surface and the outer surface of the housing and is removable from the housing main body, and
wherein the relay coil formed of the thin-film wiring is provided on at least one surface selected from a surface of the removable part that constitutes a portion of the inner surface of the housing and a surface of the removable part that constitutes a portion of the outer surface of the housing.

11. A wireless communication system according to claim 6, wherein a housing case capable of housing the small portable device comprises the relay coil.

12. A wireless communication system according to claim 6, wherein the small portable device comprises portable electronic equipment.

13. A wireless communication system according to claim 6, wherein the small portable device comprises an IC card.

14. A small portable device to be used in a wireless communication system,
the wireless communication system comprising a first coil having at least a function of transmitting signal information, a relay coil, and a second coil having at least a function of receiving the signal information, and satisfying Equation (2) below:
RO1>RO2>RO3, Equation (2)
in Equation (2), RO1 represents an outer diameter of the first coil, RO2 represents an outer diameter of the relay coil, and RO3 represents an outer diameter of the second coil,
the small portable device having at least the second coil mounted therein.

15. A housing case for a small portable device to be used in a wireless communication system,
the wireless communication system comprising a first coil having at least a function of transmitting signal information, a relay coil, and a second coil having at least a function of receiving the signal information, and satisfying Equation (3) below:
RO1>RO2>RO3, Equation (3)
in Equation (3), RO1 represents an outer diameter of the first coil, RO2 represents an outer diameter of the relay coil, and RO3 represents an outer diameter of the second coil,
the second coil being mounted in the small portable device,
the housing case being capable of housing the portable electronic equipment and comprising the relay coil.

16. A communication device for a small portable device to be used in a wireless communication system,
the wireless communication system comprising a first coil having at least a function of transmitting signal information, a relay coil, and a second coil having at least a function of receiving the signal information, and satisfying Equation (4) below:
RO1>RO2>RO3, Equation (4)
in Equation (4), RO1 represents an outer diameter of the first coil, RO2 represents an outer diameter of the relay coil, and RO3 represents an outer diameter of the second coil,
the second coil being mounted in the small portable device,
the communication device having at least the function of transmitting the signal information to the small portable device and comprising the first coil.
